(19) United States
(12) Patent Application Publication
(10) Pub. No.: US 2004/0165723 A1
(43) Pub. Date: Aug. 26, 2004

(54) Image processing apparatus, image processing system, and image information transmission method

(75) Inventors: Shinji Yoda, Kita-katsushika-gun (JP); Takuya Kotsuji, Tagata-gun (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/373,054

(22) Filed: Feb. 26, 2003

(51) Int. Cl. H04L 9/00

(52) U.S. Cl. 380/44

(57) ABSTRACT

An image processing apparatus, an image processing system, and an image information transmission method which are high in a secrecy nature in transmission of image information are provided.

The image processing apparatus has an MFP 1 which includes: a scanner section 11 for reading an image to obtain electronic data; an encryption section 12a for encrypting electronic data to be sent, which is obtained by reading an image with the scanner section 11, with electronic data, which is obtained by reading a sheet K with the scanner section 11, as encryption key data; and a network interface section 19 for sending the electronic data encrypted by the encryption section 12a to an MFP 2, and an MFP 2 which includes: a network interface section 29 for receiving the image information sent from the MFP 1 as electronic data; a scanner section 21 for reading an image to obtain electronic data; and a decryption section for decrypting the received electronic data with electronic data, which is obtained by reading an image on the sheet K with the scanner section 21, as decryption key data.

### BACKGROUND OF THE INVENTION

1. Field of the Invention

The present invention relates to an image processing apparatus, an image processing system, and an image information transmission method.

2. Description of the Related Art

Conventionally, in the case where confidential information is transmitted from a transmission side to a reception side through a network, the transmission side transmits the confidential information to the reception side after encrypting it using key information for encryption (encryption key data), and the reception side decrypts the received confidential information, which has been encrypted, using key information for decryption (decryption key data) (e.g., see Japanese Patent Laid-Open Nos. 10-247904, 2002-32528, and 2002-109409).

Incidentally, in the case where there are a plurality of parties to whom this confidential information is sent, a plurality of pieces of key information for decryption corresponding to the plurality of parties are required. In addition, in order to increase safety in transmitting the confidential information, in some cases, contents of key information are changed periodically and the contents are notified to receiving parties every time they are changed. In such a case, it is not preferable in terms of security to send the key information for decryption via a network which was used for transmission of encrypted confidential information because it is highly likely that the key information is stolen.

### SUMMARY OF THE INVENTION

The present invention has been devised in order to solve the above-described problems, and it is an object of the present invention to provide an image processing apparatus, an image processing system, and an image information transmission method which are high in a secrecy nature in transmission of image information.

In order to solve the above-described problems, the image processing apparatus in accordance with the present invention includes: an image reading section for reading an image to obtain electronic data; an encryption section for encrypting electronic data to be sent, which is obtained by reading an image with the image reading section, with electronic data, which is obtained by reading a predetermined image with the image reading section, as encryption key data; and a transmission section for sending the electronic data encrypted by the encryption section.

In this way, the encryption key data used for encryption is obtained by reading a predetermined image (e.g., an image formed on a sheet) with the image reading section. Consequently, for example, in the case where a transmission system using the same key information for both encryption and decryption is adopted, key information (the predetermined image used for encryption) necessary for decryption of confidential information to be transmitted can be easily communicated to a receiving party through a physical conveyance route (mailing, etc.) different from an electric communication line through which the confidential information is transmitted. That is, effects are realized in that key information necessary for decryption is less likely to be stolen by others and a secrecy nature in transmission of image information is increased.

### DESCRIPTION OF THE DRAWINGS

In the accompanying drawings,

FIG. 1 is a conceptual view for explaining an image processing system according to a first embodiment of the present invention;

FIG. 2 is a schematic functional block diagram for explaining a structure of the image processing system according to the first embodiment of the present invention;

FIG. 3 is a detailed functional block diagram for explaining the image processing system according to the first embodiment of the present invention;

FIG. 4 is a flowchart for explaining a flow of processing in an MFP (multifunctional peripheral apparatus) 1 of the image processing system according to the first embodiment of the present invention;

FIG. 5 is a flowchart for explaining a flow of processing in an MFP 2 of the image processing system according to the first embodiment of the present invention;

FIG. 6 is a functional block diagram showing a structure of an image processing system according to a second embodiment of the present invention;

FIG. 7 is a schematic functional block diagram for explaining a structure of an image processing system according to a third embodiment of the present invention;

FIG. 8 is a detailed functional block diagram for explaining the image processing system according to the third embodiment of the present invention;

FIG. 9 is a flowchart for explaining a flow of processing in an MFP 1″ of the image processing system according to the third embodiment of the present invention; and

FIG. 10 is a flowchart for explaining a flow of processing in an MFP 2″ of the image processing system according to the third embodiment of the present invention.

### DETAILED DESCRIPTION OF THE PREFERRED EMBODIMENTS

An image processing apparatus, an image processing system, and an image information transmission method according to embodiments of the present invention will be hereinafter described with reference to the accompanying drawings.

### First Embodiment

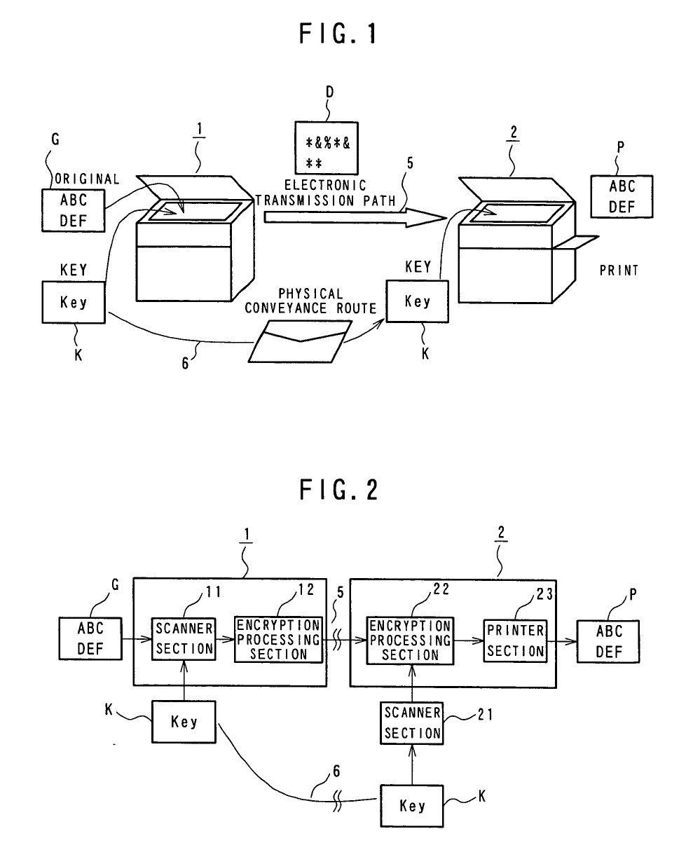

FIG. 1 is a conceptual view for explaining an image processing system according to a first embodiment of the present invention, and FIG. 2 is a schematic functional block diagram for explaining a structure of the image processing system. The image processing system according to this embodiment includes an MFP (multifunctional peripheral apparatus) 1 serving as an image processing apparatus and an MFP 2 serving as an image processing apparatus which is connected to the MFP 1 through an electric communication line 5 so as to be able to communicate with each other.

The MFP 1 (equivalent to a first image processing apparatus) includes a scanner section (first image reading section) 11, an encryption processing section 12, and a not-shown printer section (details of which will be described later). The MFP 2 (equivalent to a second image processing apparatus) includes a scanner section (second image reading section) 21, an encryption processing section 22, and a printer section (image forming section) 23. Details of these sections will be described later.

An outline of data transmission of an original G including confidential information from the MFP 1 to the MFP 2 will be hereinafter described. First, electronic data (electronic data to be sent) is obtained by reading an image on a reading surface of the original G with the scanner section 11 of the MFP 1. Next, image information obtained by reading the image with the scanner section 11 is inputted in the encryption processing section 12. Subsequently, an image (first predetermined image) on a sheet K, on which a key information image as a predetermined image prepared in advance is formed, is read by the scanner section 11, and obtained electronic data is inputted in the encryption processing section 12 as encryption key data. Then, the image on the original G is encrypted (scrambled) by the encryption processing section 12 based upon the encryption key data obtained by reading the key information image. Image information D of the original G encrypted in this way is transmitted to the MFP 2 on the reception side through the electric communication line 5 (see FIG. 1).

Then, the sheet K used for the encryption processing in the MFP 1 is transported to the MFP 2 side through a physical conveyance route 6 such as mailing.

On the other hand, on the MFP 2 side, the information (encrypted information) transmitted from the MFP 1 side through the electric communication line 5 is received, and the received information is inputted in the encryption processing section 22. Then, an image (second predetermined image) of the sheet K transported to the MFP 2 side through the physical conveyance route 6 is read by the scanner section 21 and inputted in the encryption processing section 22. In this way, the received image information of the original G, which has been encrypted, is decrypted by the encryption processing section 22 with the electronic data obtained by reading the image on the sheet K as decryption key data.

Through the processing as described above, the decrypted image information of the original G is printed out by the printer section 23, which is arranged in the MFP 2, as required.

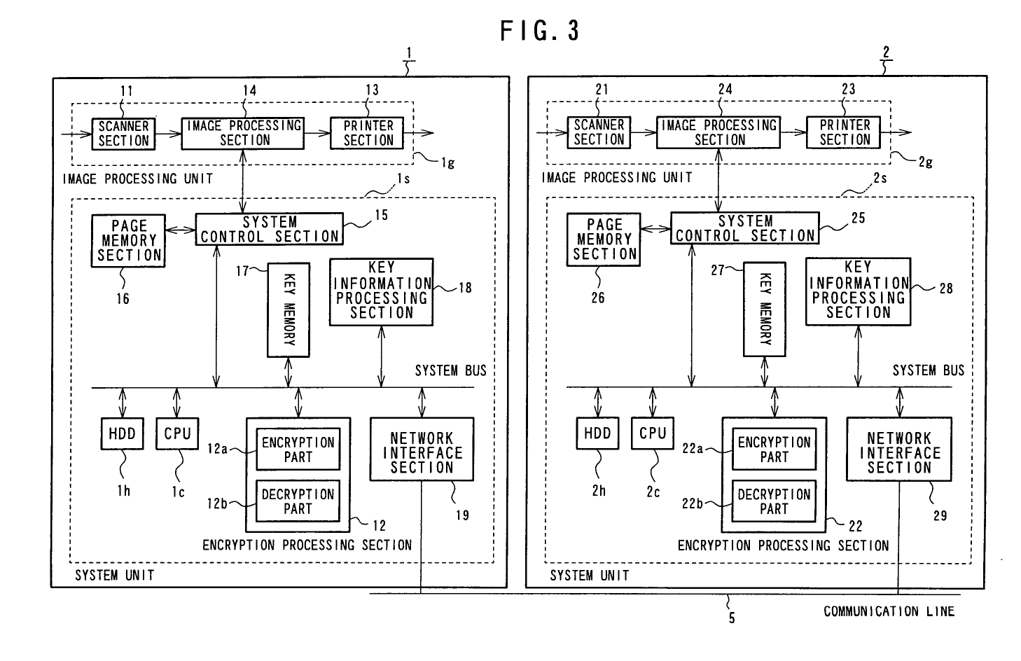

Next, the image processing system will be described in detail with reference to FIGS. 3 to 5.

The MFP 1 includes, more specifically, an image processing unit 1g having the scanner section 11, a printer section 13, and an image processing section 14, and a system unit Is having a system control section 15, a page memory section 16, a key memory 17, a key information processing section 18, an HDD 1h, a CPU 1c, a network interface section (having roles of both a transmission section and a reception section) 19, and the encryption processing section 12. In addition, the encryption processing section 12 includes an encryption part 12a and a decryption part 12b.

On the other hand, the MFP 2 includes an image processing unit 2g having the scanner section 21, the printer section 23, and an image processing section 24, and a system unit 2s having a system control section 25, a page memory section 26, a key memory 27, a key information processing section 28, an HDD 2h, a CPU 2c, a network interface section 29, and the encryption processing section 22. In addition, the encryption processing section 22 includes an encryption part 22a and a decryption part 22b. As described above, the MFP 1 and the MFP 2 have the same structure.

Further, the MFP 1 and the MFP 2 are connected through the electric communication line 5 by a network interface section provided therein, respectively, so as to be able to communicate with each other.

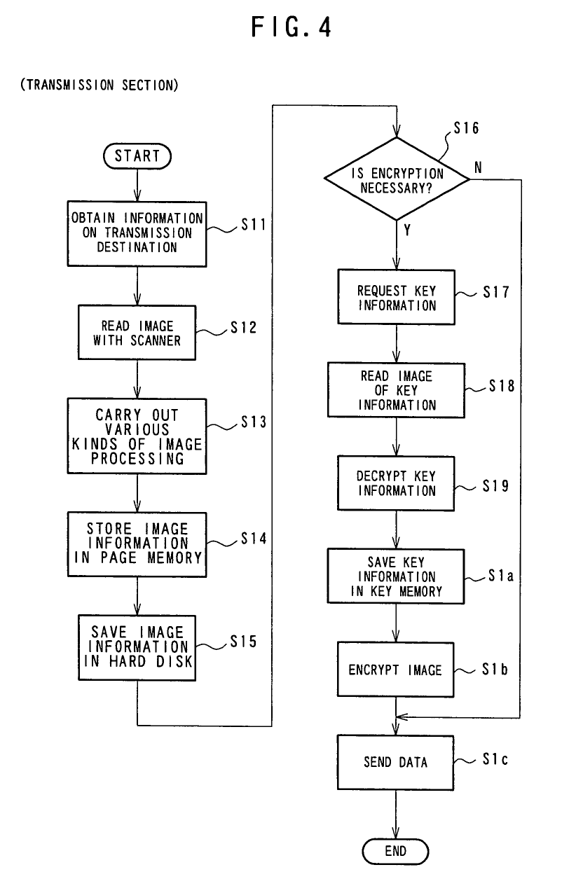

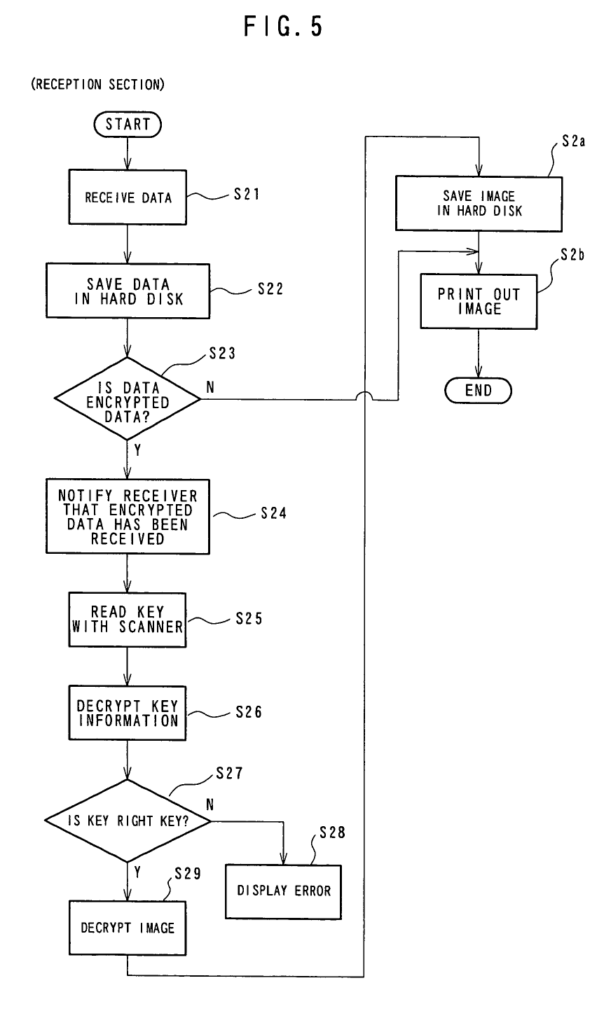

Next, a flow of operations of the image processing system according to this embodiment will be described with reference to flowcharts shown in FIGS. 4 and 5. FIG. 4 shows a flow of processing in the MFP 1 which is a transmission side. FIG. 5 shows a flow of processing in the MFP 2 which is a reception side.

A flow of a transmission operation in the MFP 1 will be described. First, transmission destination information (telephone number, device specifications, etc.) on a transmission destination to which image information of the original G is to be sent is obtained (S11). Subsequently, an image on the reading surface of the original G is read by the scanner section 11 (S12). Then, various kinds of edition processing are applied to the image information, which is read from the original G, in the image processing section 14 as required (S13). In this way, the image information, which is ready to be sent, is stored in the page memory section 16 of the system unit 1s (S14) and saved in the HDD 1h (S15).

Here, it is selected on a not-shown control panel (equivalent to an encryption mode selection section) whether or not encryption is performed when the original G is sent (S16). If it is unnecessary to perform encryption here, the image information saved in the HDD 1h is sent to the transmission destination directly (S1c).

On the other hand, in the case where it is necessary to perform encryption when the original G is sent, the sheet K having the key information image, which is used as an encryption key when the encryption is performed, formed thereon is requested on the not-shown control panel (S17). Then, the key information image on the reading surface of the sheet K is read by the scanner section 11 (S18), and key information is decrypted by the key information processing section 18 (S19). The decrypted key information is saved in the key memory 17 (S1a).

Then, the image information of the original G is encrypted by the encryption part 12a of the encryption processing section 12 in the system unit is using the key information saved in the key memory 17 (S1b), and is sent via the network interface section 19 (S1c).

Next, a flow of a reception operation in the MFP 2 will be described. First, the image information sent from the MFP 1 side via the electric communication line 5 is received via the network interface section 29 on the MFP 2 side (S21). Then, the received image information is saved in the HDD 2h (S22).

Subsequently, it is judged whether or not the received data is encrypted image information (S23). If the received data is not encrypted data, it is printed out by the printer section 23 (S2b).

On the other hand, in the case where the received data is encrypted image information, it is notified to a receiver by display on the not-shown control panel, voices, or the like that the encrypted data has been received (S24).

Note that the judgment of whether or not the received data is encrypted data and the specification of a receiver can be performed in a not-shown data judgment section according to information incorporated in header information of the received data.

Then, the key information image of the sheet K transported to the MFP 2 side (i.e., receiver side) through the physical conveyance route 6 is read by the scanner section 21 (S25) to obtain the key information. Subsequently, the key information is decrypted by the key information processing section 28 (S26).

Next, it is judged whether or not the key decrypted by the key information processing section is a right key (i.e., a decryption key corresponding to the encryption key used for encrypting the received image information) (S27). If the key information image read by the scanner section 21 is not a right one as a result of the judgment, error display is performed on the not-shown control panel (S28).

On the other hand, if the key information is a right one, decryption processing of the received data is performed using the read key information by the decryption part 22b of the encryption processing section 22 in the system unit 2s (S29).

Thereafter, the decrypted image is saved in the HDD 2h (S2a) and printed out by the printer section 23 (S2b).

As described above, according to this embodiment, since key information necessary for decryption of confidential information to be transmitted is communicated through a physical conveyance route different from an electric communication line through which the confidential information is transmitted, an effect is realized in that a secrecy nature of information is increased.

In addition, the sheet K on which a key information image is shown is sent to the other party by mailing or the like, whereby a party to whom key information to be used for decryption is passed (party to whom an authority of decryption is given) can be specified and restricted, and improvement of the secrecy nature can be improved. In this way, since a party to whom key information to be used for decryption is passed can be specified and restricted, even in the case where chargeable information is sent to the party, the party is caused to purchase the key information to be mailed using a service such as cash on delivery, whereby collection of money can be performed efficiently.

Moreover, since the image processing system is constituted so as to obtain key information to be used for encryption and decryption by reading it with a scanner section, an operation of the system becomes easy and a wide variety of users can use the system.

In the description of this embodiment, the case in which the MFP 1 is a transmission side and the MFP 2 is a reception side is shown. However, it is needless to mention that the present invention is not limited to this but functions in the case where the MFP 2 is a transmission side and the MFP 1 is a reception side as well.

Note that, in this embodiment, the example in which information is transmitted through an electric communication line is shown. However, it is needless to mention that the present invention is not limited to this and transmission of information according to an optical communication system, which is realized by connecting a transmission side and a reception side with an optical fiber cable, or a wireless communication system is also possible.

As described above, according to this embodiment, the image processing system is constituted so as to obtain key data to be used for encryption and decryption by reading a predetermined image (i.e., a key information image formed on a sheet, etc.) with a scanner section, whereby the key data can be easily obtained from a sheet on which the predetermined image is formed. In addition, key data to be used for encryption and decryption is held by a sheet or the like as an image, decryption key data (second predetermined image) required when encrypted information is received can be easily received through a physical conveyance route (mailing, etc.) different from an electric communication line through which confidential information is transmitted. Naturally, even in the case where it is desired to pass encryption key data (first predetermined image) used for encryption to a transmission destination, it can be easily passed through the physical conveyance route in the same manner. This is particularly effective in the case where the same key data is utilized for the encryption key and the decryption key as in this embodiment. In this way, an effect is realized in that key information necessary for decryption becomes less likely to be stolen by others and a secrecy nature in transmission of image information is increased.

In addition, since the image processing system is constituted such that key data can be obtained by reading an image with a scanner section, an effect is realized in that an operation of the system becomes easy and, even in the case where the key data is changed frequently, a wide variety of users can use the system easily.

Moreover, since the image processing system is constituted so as to use a scanner section, which is used in reading an image to be sent, in inputting key data as well, it is unnecessary to provide an input section for inputting encryption key data anew. This contributes to miniaturization of an apparatus.

Note that, in order to perform the image information transmission processing described in this embodiment, it is also effective to constitute a program described below as a program to be executed by a CPU in an MFP. That is, the program is an image information transmission program for transferring image information from a first image processing apparatus to a second image processing apparatus, which includes: a step of reading a first predetermined image in the first image processing apparatus; a step of encrypting electronic data obtained by reading an image to be sent with electronic data obtained by reading the first predetermined image as encryption key data; a step of sending the encrypted electronic data to the second image processing apparatus; a step of receiving image information sent from the first image processing apparatus in the second image processing apparatus as electronic data; a step of reading a second predetermined image in the second image processing apparatus; and a step of decrypting the received electronic data with electronic data obtained by reading the second predetermined image as decryption key data.

### Second Embodiment

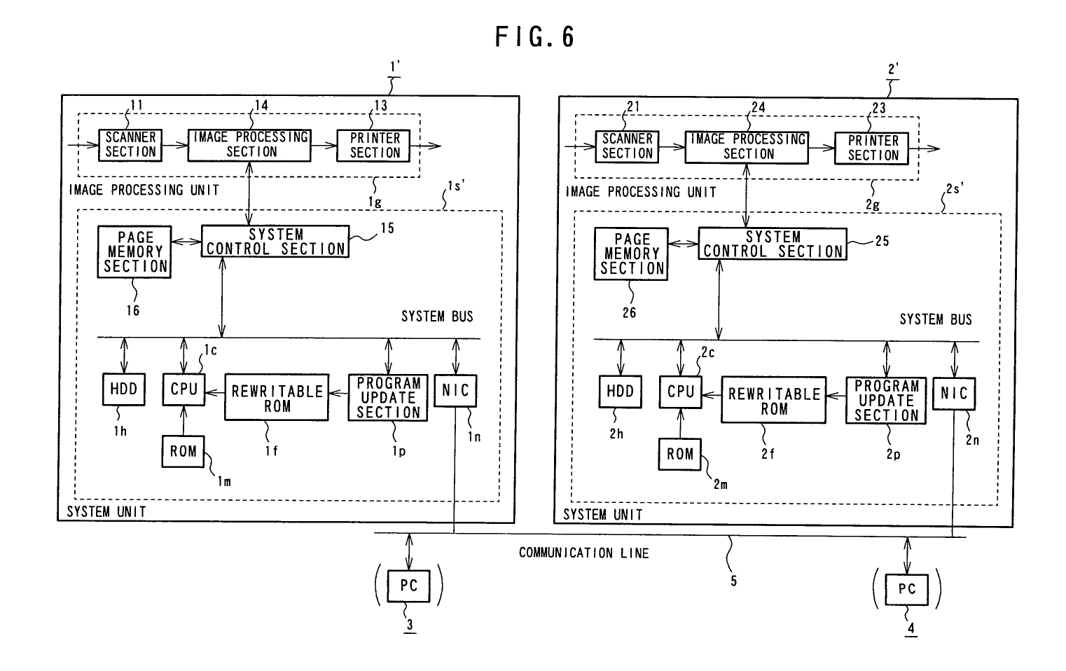

Next, an image processing apparatus, an image processing system, and an image information transmission method according to a second embodiment of the present invention will be described. FIG. 6 is a functional block diagram showing a structure of the image processing system according to this embodiment. This embodiment is a modified example of the above-described first embodiment. In the following description, components identical with those described above will be denoted by the identical reference symbols, and descriptions of the components will be omitted.

The image processing system in this embodiment includes an MFP 1′ (first image processing apparatus) and an MFP 2′ (second image processing apparatus) which is connected to the MFP 1′ through the electric communication line 5 so as to be able to communicate with each other.

In this embodiment, an encryption processing section (the encryption processing section 12 in FIG. 3, etc.) as hardware is not provided in a system unit of an MFP. Instead, an encryption processing program (software) for performing encryption processing is stored in a storage area of a rewritable ROM or the like, and a CPU of a computer is caused to execute the encryption processing program as required to perform encryption processing.

The MFP 1′ includes, more specifically, the image processing unit 1g having the scanner section 11, the printer section 13, and the image processing section 14, and a system unit 1s′ having the system control section 15, the page memory section 16, the HDD 1h, the CPU 1c, a ROM 1m, a rewritable ROM 1f, a program update section 1p, and an NIC (network interface card) In. The MFP 1′ is connected to a PC (personal computer) 3 via the NIC 1n and is capable of transmitting and receiving information through the electric communication line 5.

On the other hand, the MFP 2′ includes the image processing unit 2g having the scanner section 21, the printer section 23, and the image processing section 24, and a system unit 2s′ having the system control section 25, the page memory section 26, the HDD 2h, the CPU 2c, a ROM 2m, a rewritable ROM 2f, a program update section 2p, and an NIC (network interface card) 2n. The MFP 2′ is connected to a PC (personal computer) 4 via the NIC 2n and is capable of transmitting and receiving information through the electric communication line 5.

Then, the MFP 1′ and the MFP 2′ are capable of transmitting and receiving information with each other through the electric communication line 5 with the PCs 3 and 4 to which the NIC 1n and the NIC 2n provided in the MFP 1′ and the MFP 2′, respectively, are connected.

Next, a flow of operations of the image processing system according to this embodiment will be described. Since the operations of the image processing system according to this embodiment and the image processing system in the first embodiment are substantially the same in the flow of main processing, differences of the operations will be described. This embodiment is different from the first embodiment in that encryption and decryption of image information is performed by causing a CPU to execute an encryption processing program including an encryption program and a decryption program, whereas the encryption processing section serving as hardware is caused to perform the processing of encryption and decryption of image information in the first embodiment.

According to this embodiment, even in the case where an apparatus to be a destination of transmission at the time of transmission is not provided with hardware equivalent to the encryption processing section, since the encryption processing program is transmitted through a network, it becomes possible to perform encryption and decryption in the destination of transmission as well.

### Third Embodiment

Next, an image processing apparatus, an image processing system, and an image information transmission method according to a third embodiment of the present invention will be described. This embodiment is a modified example of the first and second embodiments. In the first and second embodiments, key information is obtained by reading a sheet having a key information image formed thereon to perform encryption and decryption. However, in this embodiment, key information (encryption key data) Kd is held in advance so as to be utilized as data and is read out to be utilized as required. In the following description, components identical with those described above will be denoted by the identical reference symbols, and descriptions of the components will be omitted.

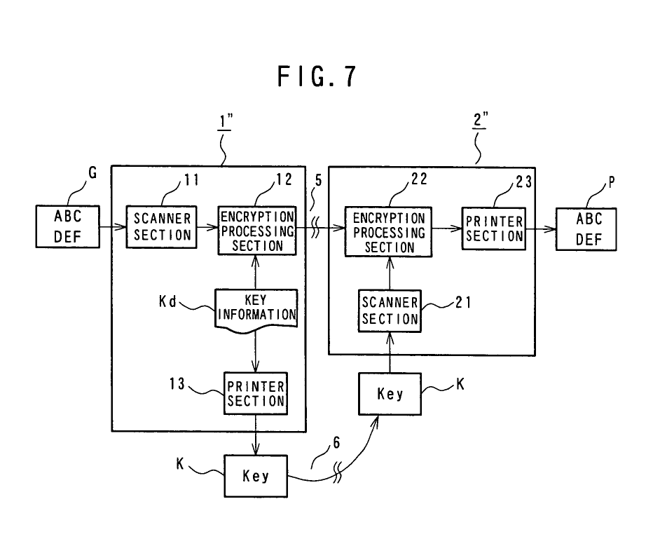

FIG. 7 is a schematic functional block diagram for explaining a structure of the image processing system according to the third embodiment of the present invention. The image processing system according to this embodiment includes an MFP (multifunctional peripheral apparatus) 1″ serving as a first image processing apparatus and an MFP 2″ serving as a second image processing apparatus which is connected to the MFP 1″ through the electric communication line 5 so as to be able to communicate with each other.

The MFP 1″ includes the scanner section 11, the encryption processing section 12, and the printer section 13. The MFP 2″ includes the scanner section 21, the encryption processing section 22, and the printer section 23. Details of these sections will be described later.

A flow of processing at the time of data transmission of the original G including confidential information from the MFP 1″ to the MFP 2″ will be hereinafter described. First, in the MFP 1″, an image on the reading surface of the original G is read by the scanner section 11. Next, image information (electronic data to be sent) obtained by reading the image with the scanner section 11 is inputted in the encryption processing section 12.

Subsequently, predetermined key information Kd stored in a not-shown storage area (storage section) in the MFP 1′ in advance as image information is read out, and the obtained key information Kd is inputted in the encryption processing section 12.

Then, the image of the original G is encrypted (scrambled) by the encryption processing section 12 based upon the key information (encryption key data) Kd. The image information of the original G encrypted in this way is transmitted to the MFP 2″ on the reception side through the electric communication line 5.

Then, the key information Kd used for the encryption processing in the MFP 1″ is printed out on the sheet K as an image by the printer section 13. The sheet K on which the key information Kd is printed out is transported to the MFP 2″ side through the physical conveyance route 6 such as mailing.

On the other hand, on the MFP 2′ side, the information (encrypted image information of the original G) transmitted from the MFP 1″, side through the electric communication line 5 is received, and the received information is inputted in the encryption processing section 22. Then, the image on the sheet K transported to the MFP 2″ side through the physical conveyance route 6 is read by the scanner section 21 and inputted in the encryption processing section 22. In this way, the encrypted image information of the original G is decrypted by the encryption processing section 22 with the electronic data obtained by reading the key information image (image printed out by the printer section 13) as decryption key data.

The image information of the original G decrypted through the above-mentioned processing is printed out as a sheet P by the printer section 23, which is arranged in the MFP 2″, as required.

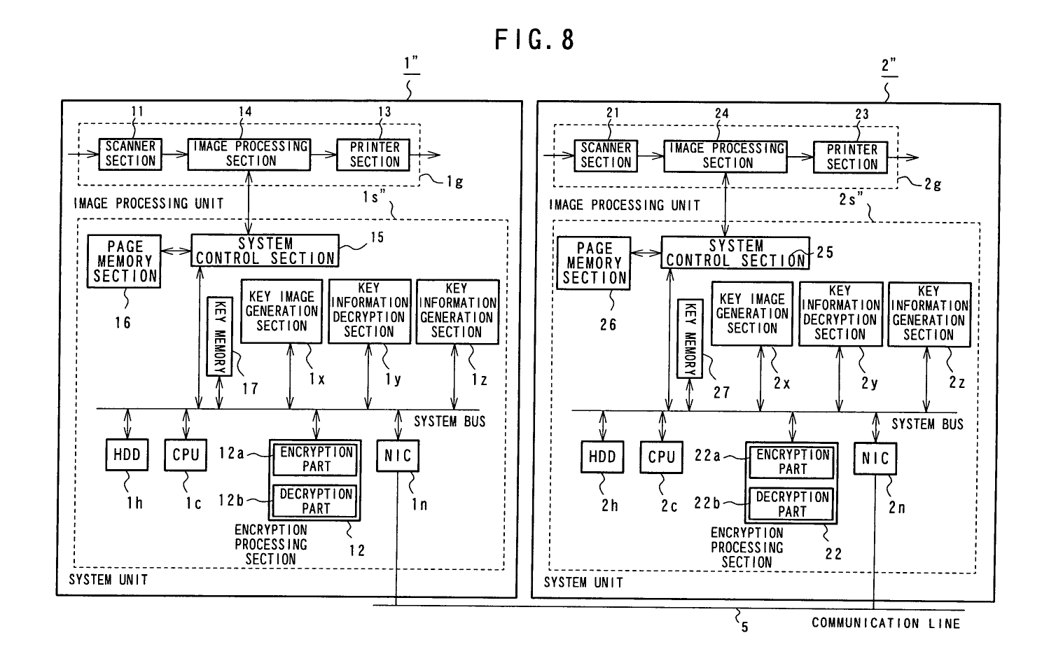

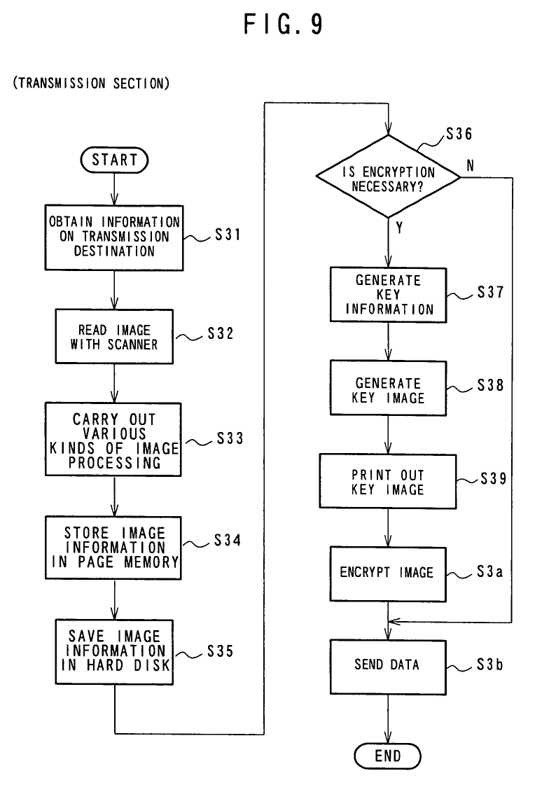

Next, the above-described image processing system will be described in detail with reference to FIGS. 8 to 10.

The MFP 1″ includes, more specifically, the image processing unit 1g having the scanner section 11, the printer section 13, and the image processing section 14, and a system unit 1s″ having the system control section 15, the page memory section 16, the key memory 17, a key image generation section 1x, a key information decryption section 1y, a key information generation section 1z, the HDD 1h, the CPU 1c, the NIC (equivalent to a transmission section and a reception section) 1n, and the encryption processing section 12. In addition, the encryption processing section 12 has the encryption part 12a and the decryption part 12b.

On the other hand, the MFP 2″ includes the image processing unit 2g having the scanner section 21, the printer section 23, and the image processing section 24, and a system unit 2s″ having the system control section 25, the page memory section 26, the key memory 27, a key image generation section 2x, a key information decryption section 2y, a key information generation section 2z, the HDD 2h, the CPU 2c, the NIC (equivalent to a transmission section and a reception section) 2n, and the encryption processing section 22. In addition, the encryption processing section 22 has the encryption part 22a and the decryption part 22b. In this way, the MFP 1″ and the MFP 2″ have the same structure.

The MFP 1″ and the MFP 2″ are made connectable to the electric communication line 5 via the NIC 1n and the NIC 2n, whereby transmission and reception of information via the NICs is possible between the MFP 1″ and the MFP 2″.

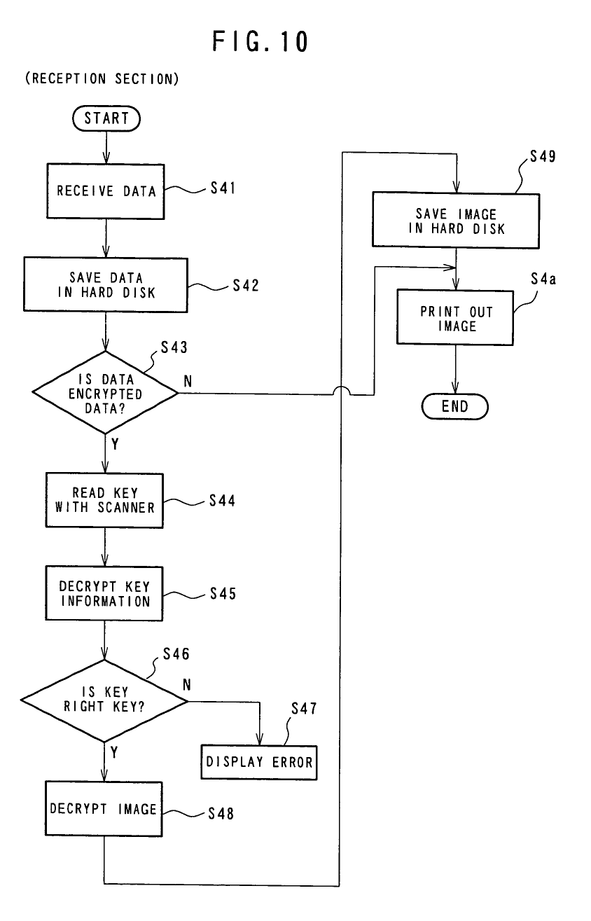

Next, a flow of operations of the image processing system according to this embodiment will be described with reference to flowcharts shown in FIGS. 9 and 10. FIG. 9 shows a flow of processing in the MFP 1″ which is a transmission side. FIG. 10 shows a flow of processing in the MFP 2″ which is a reception side.

A flow of a transmission operation in the MFP 1″ will be described. First, transmission destination information (telephone number, device specifications, etc.) on a transmission destination to which image information of the original G is to be sent is obtained (S31). Subsequently, an image on the reading surface of the original G is read by the scanner section 11 (S32). Then, various kinds of edition processing are applied to the image information, which is read from the original G, in the image processing section 14 as required (S33). In this way, the image information, which is ready to be sent, is stored in the page memory section 16 of the system unit 1s′ (S34) and saved in the HDD 1h (S35).

Here, it is selected on the not-shown control panel whether or not encryption is performed when the original G is sent (S36). If it is unnecessary to perform encryption here, the image information saved in the HDD 1h is sent to the transmission destination directly (S3b).

On the other hand, in the case where it is necessary to perform encryption when the original G is sent, key information Kd, which is used as an encryption key when encryption is performed, is generated by the key information generation section 1z (S37). Then, a key information image is generated by the key image generation section 1x based upon the generated key information Kd (S38), and the key information image is printed out by the printer section 13 (S39). The key information generated by the key information generation section 1z is saved in the key memory 17. Note that the generation of key information here can also be performed based upon, for example, electronic data obtained by reading a sheet having a predetermined or arbitrary image with the scanner section. As an image to be read by the scanner section in the generation of key information, for example, an image according to the computer-scored answer sheet system, which a user can determine arbitrarily, can also be used.

Then, the image information of the original G is encrypted by the encryption part 12a of the encryption processing section 12 in the system unit 1s″ using the key information saved in the key memory 17 (S3a) and is sent to the MFP 2″ via the NIC in (S3b).

The sheet K on which the key information image is printed out is transported to the MFP 2″ side via the physical conveyance route 6 such as mailing.

Next, a flow of a reception operation in the MFP 2″ will be described. First, image information sent from the MFP 1″ side via the electric communication line 5 is received on the MFP 2″ side (S41). Then, the received image information is saved in the HDD 2h (S42).

Subsequently, it is judged whether or not the received data is encrypted image information (S43). If the received data is not encrypted data, it is printed out by the printer section 23 (S4a).

On the other hand, in the case where the received data is encrypted image information, it is notified to a receiver by display on the not-shown control panel, voices, or the like that the encrypted data has been received.

Note that the judgment of whether or not the received data is encrypted data and the specification of a receiver can be performed according to information incorporated in header information of the received data.

Then, the key information image of the sheet K transported to the MFP 2″ side (i.e., receiver side) through the physical conveyance route 6 is read by the scanner section 21 (S44) to obtain the key information. Subsequently, the key information is decrypted by the key information decryption section 2y (S45).

Next, it is judged whether or not the key decrypted by the key information decryption section 2y is a right key (i.e., a decryption key corresponding to the encryption key used for encrypting the received image information) (S46). If the key information image read by the scanner section 21 is not a right one as a result of the judgment, error display is performed on the not-shown control panel (S47).

On the other hand, if the key information is a right one, decryption processing of the received data is performed using the read key information by the decryption part 22b of the encryption processing section 22 in the system unit 2s″ (S48).

Thereafter, the decrypted image is saved in the HDD 2h (S49) and printed out by the printer section 23 (S4a).

As described above, according to this embodiment, even if encrypted information is stolen in an electric communication line, key information necessary for decryption of confidential information to be transmitted is communicated through a physical conveyance route different from the electric communication line through which the confidential information is transmitted. Thus, transmission of information with a high secrecy nature and safety can be performed.

In addition, encryption key data to be used for encryption is stored in a storage section, and the encryption key data used for encryption processing can be printed out on a sheet or the like as an image, whereby the encryption key data can be easily sent by mail or the like to a transmission destination.

Further, in the description of this embodiment, the case in which the MFP 1″ is a transmission side and the MFP 2″ is a reception side is shown. However, it is needless to mention that the present invention is not limited to this but functions in the case where the MFP 2″ is a transmission side and the MFP 1″ is a reception side as well.

Note that, in this embodiment, the example in which information is transmitted through the electric communication line 5 is shown. However, it is needless to mention that the present invention is not limited to this and transmission of information according to an optical communication system, which is realized by connecting a transmission side and a reception side with an optical fiber cable, or a wireless communication system is also possible.

Moreover, the key information Kd stored in advance in this embodiment may be stored in a storage area of a memory, an HDD, or the like in an MFP or may be stored in a storage medium such as an MO, an FD, or a CD-ROM. Naturally, the key information Kd can also be stored in an external device, which is connected to the MFP so as to be able to communicate with each other, and read out through a network as required. In addition, it is also possible to store (register) key information, which is obtained by reading a sheet on which a key information image is formed with a scanner section provided in the MFP, as the key information Kd in the above-described storage area.

Note that, in order to perform the image information transmission processing described in this embodiment, it is also effective to constitute a program described below as a program to be executed by a CPU in an MFP. That is, the program is an image information transmission program for transferring image information from a first image processing apparatus to a second image processing apparatus, which includes: a step of encrypting electronic data obtained by reading an image to be sent based upon encryption key data stored in a storage section in the first image processing apparatus; a step of printing out the encryption key data as an image; a step of sending the encrypted electronic data to the second image processing apparatus; a step of receiving image information sent from the first image processing apparatus in the second image processing apparatus as electronic data; a step of reading the image printed out by the first image processing apparatus in the second image processing apparatus; and a step of decrypting the received electronic data with electronic data obtained by reading the printed out image as decryption key data.

In the above-described embodiments, the example in which an MFP is used in a transmission side and a reception side is shown. However, it is needless to mention that the present invention is not limited to this but is applicable to transmission of information using a facsimile or a PC instead of the MFP.

Note that, as the sheet K used in the first and second embodiments, in addition to a sheet on which a key information image used as an encryption key in performing encryption is formed in advance, a sheet on which key information can be arbitrarily determined by a user according to the computer-scored answer sheet system can be used.

As indicated in the above-described embodiments, since reception with a different decryption key for each receiver is made possible, even an MFP which is usually shared by a plurality of people can receive information while maintaining a secrecy nature of the information.

In addition, in the above-described embodiments, identical key information is used for encryption and decryption of confidential information. However, it is needles to mention that the present invention is not limited to this, and key information to be used for encryption and key information to be used for decryption may be different. That is, a first predetermined image and a second predetermined image may be different.

Further, in the above-described embodiments, as encryption key data and decryption key data which are electronic data obtained by reading an image on a sheet in a scanner section, a character string of data read as usual image data may be used, or a part of the character string of the image data may be utilized as key data. Naturally, the key data can also be generated based upon all or a part of the character string of the image data.

Note that it is possible to apply publicly-known various encryption and decryption methods to encryption and decryption processing based upon the key data obtained in this way.

As described above in detail, according to the present invention, an image processing apparatus, an image processing system, and an image information transmission method which are high in a high secrecy nature in transmission of image information can be provided.

What is claimed is:

1. An image processing apparatus comprising:
an image reading section for reading an image to obtain electronic data;
an encryption section for encrypting electronic data to be sent, which is obtained by reading an image with said image reading section, with electronic data, which is obtained by reading a predetermined image with said image reading section, as encryption key data; and
a transmission section for sending the electronic data encrypted by said encryption section.

2. The image processing apparatus according to claim 1, further comprising an encryption mode selection section for selecting whether or not data to be sent is encrypted and sent.

3. The image processing apparatus according to claim 1, further comprising:
a reception section for receiving image information as electronic data; and
a decryption section for decrypting the received electronic data with electronic data obtained by reading a predetermined image with said image reading section as decryption key data.

4. The image processing apparatus according to claim 3, further comprising a data judgment section for judging whether or not the electronic data is encrypted based upon header information of the received electronic data.

5. An image processing system for transferring image information from a first image processing apparatus to a second image processing apparatus,
wherein said first image processing apparatus comprises:
a first image reading section for reading an image to obtain electronic data;
an encryption section for encrypting electronic data to be sent, which is obtained by reading an image with said first image reading section, with electronic data, which is obtained by reading a first predetermined image with said first image reading section, as encryption key data; and
a transmission section for sending the electronic data encrypted by said encryption section to said second image processing apparatus, and
said second image processing apparatus comprises:
a reception section for receiving image information sent from said first image processing apparatus as electronic data;
a second image reading section for reading an image to obtain electronic data; and
a decryption section for decrypting the received electronic data with electronic data, which is obtained by reading a second predetermined image with said second image reading section, as decryption key data.

6. The image processing system according to claim 5,
wherein the first predetermined image and the second predetermined image are identical images formed on an identical sheet.

7. The image processing system according to claim 5,
wherein said first image processing apparatus comprises an encryption mode selection section for selecting whether or not data to be sent is encrypted and sent.

8. The image processing system according to claim 5,
wherein said second image processing apparatus comprises a data judgment section for judging whether or not the electronic data is encrypted based upon header information of the received electronic data.

9. An image information transmission method for transferring image information from a first image processing apparatus to a second image processing apparatus, comprising steps of:
reading a first predetermined image in said first image processing apparatus;
encrypting electronic data, which is obtained by reading an image to be sent, with electronic data, which is obtained by reading the first predetermined image, as encryption key data;
sending the encrypted electronic data to the second image processing apparatus;
receiving image information sent from said first image processing apparatus in said second image processing apparatus as electronic data;
reading a second predetermined image in said second image processing apparatus; and
decrypting the received electronic data with electronic data, which is obtained by reading the second predetermined image, as decryption key data.

10. The image information transmission method according to claim 9,
wherein the first predetermined image and the second predetermined image are identical images formed on an identical sheet.
